(19) United States
(12) Patent Application Publication
(10) Pub. No.: US 2003/0023700 A1
(43) Pub. Date: Jan. 30, 2003

(54) System and methodology providing on-board user interface

(75) Inventors: William Swinton, Santa Cruz, CA (US); Eric Bodnar, Santa Cruz, CA (US); Jerome Garcia, Soquel, CA (US)

Correspondence Address: JOHN A. SMART, 708 BLOSSOM HILL RD., #201, LOS GATOS, CA, 95032, US

(73) Assignee: LightSurf Technologies, Inc.

(21) Appl. No.: 10/052,284

(22) Filed: Jan. 17, 2002

Related U.S. Application Data
(60) Provisional application No. 60/308,511, filed on Jul. 27, 2001.

(51) Int. Cl. G06F 15/16

(52) U.S. Cl. 709/208; 710/8

(57) ABSTRACT

An “on-board” user interface system is described that allows a user interface of a first device to be supported at least in part by a second device. In an exemplary embodiment, the system comprises a module for generating at least one high-level event message indicating that an event has occurred that is relevant to the first device; a mapper for mapping the at least one high-level message into at least one lower-level message for controlling one or more hardware elements controlled by the second device; and a module for communicating the at least one lower-level message to the second device, such that the second device may activate one or more hardware elements that are appropriate for the event that has occurred.

### RELATED APPLICATIONS

The present application is related to and claims the benefit of priority of the following commonly-owned provisional application(s): application serial No. 60/308,511 (Docket No. LS/0028.00), filed Jul. 27, 2001, entitled “System and Methodology Providing Onboard User Interface”, of which the present application is a non-provisional application thereof. The present application is related to the following commonly-owned application(s): application Ser. No. 09/434,703 (Docket No. LS/0001.01), filed Nov. 5, 1999, entitled “Improved Digital Camera Device and Methodology for Distributed Processing and Wireless Transmission of Digital Images”. The disclosures of each of the foregoing applications are hereby incorporated by reference in their entirety, including any appendices or attachments thereof, for all purposes.

### COMPUTER PROGRAM LISTING APPENDIX

A Computer Program Listing Appendix, containing six (6) total files on compact disc, is included with this application.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF THE INVENTION

1. Field of the Invention

The present invention relates to improved implementation of user interfaces of user-operated devices, particularly when such devices are “hosted” by other devices.

2. Description of the Background Art

Today, a multitude of different types of user-operated devices exist. For example, “media capture devices” exist for capturing (i.e., recording) media, such as audio, video, and digital images. Common examples of these types of devices include digital cameras, digital audio recorders, and digital video recorders. Media capture devices, being user-operated devices, include an interface (i.e., user interface) facilitating user operation. For example, a device will include a particular user interface for facilitating user operation of the device's buttons. In the case of a media capture device, a device's user interface may afford feedback (e.g., preview) and allow the user to control the capturing process. Additionally, the device's user interface may assist with the storage, transfer, and exchange (e.g., uploading) of images that the device has captured. Typically, the exact functionality of a given user interface is designed to be an integral part of a particular device. The user interface is designed for a very specific device and, as a result, is only suited for that specific device.

The foregoing approach of designing a user interface for a specific device is problematic. Often, a media capture device is designed to be an “add on”—that is, a device that is to be added onto (e.g., clipped onto) another target or host device, or the device may even be designed to be embedded (i.e., completely housed within) another device. For example, “clip-on” digital camera devices available today include the capability of being “hosted” by different target devices, such as cell phone devices and PDA (personal digital assistant) devices. As a result, the user interface facilities of a media capture device, including for instance buttons and LCD screen, may actually be located on the hosting device (as opposed to the media capture device itself). For example, when a digital camera is connected to a hosting device, the user's interaction with the camera is determined by the combination of user interface support provided by the hosting device and the camera. The user interface capabilities of the hosting device that are accessible to the camera may be limited to none or may include some combination of support for access to buttons, buzzer, indicators, display screen, speaker, microphone, and event notification. The camera itself may provide a similar set of user interface capabilities. This poses an immediate problem: how is the hosting device able to lend the desired user interface functionality for supporting a particular hosted or client device (e.g., media capturing device) to which it has been connected?

Typically, when one device hosts another device, both devices must include nontrivial mechanisms that implement the desired user interface. Thus, for example, when a PDA (personal digital assistant) device hosts a clip-on camera, the PDA includes complex program logic (e.g., custom software) specifying specific user interface support. With that approach, the PDA includes intimate knowledge about the implementation details of the clip-on camera. The program logic required, whether installed in the hosting device or loaded/injected into the device (either manually or automatically), is complex and is tied to the underlying application programming interfaces (APIs) of the host (which may or may not be publicly available). Thus, to date, the approach adopted has been, in effect, to connect devices together using a device-specific, inflexible approach.

The foregoing disadvantage is particularly severe when the hosting device already exists in the field and it is desirable to add new functionality that allows the hosting device to host new client devices, such as a new media capture device. Because of the inherent complexity of capturing media, users must be provided with reasonable user interface designs to assist with the capturing task. User interface features such as buttons, screens, or other input/output facilities are difficult to add to devices that have already been produced, and are even difficult to add to devices for which production is still being contemplated. For example, requiring a hosting device, such as a cell phone or PDA, to include a non-trivial driver or other customized logic for supporting a media capturing (client) device greatly increases the difficulty of manufacturing and maintaining the hosting device.

The problem actually manifests itself even when a device is wholly self-contained (i.e., it is not hosted). The core features of the device (e.g., media capture) must still interface with external features of the device (e.g., buttons and display screen) that are present on the device's housing. Consider, for example, a present-day video camera. That media capture device would include a machine and logic for providing the user interface and a machine and logic for providing media capture. Here, the media capture portion is designed to specifically operate with the user interface portion of the device. The degree of effort and complexity required for coordinating the two portions is non-trivial. Thus, the problem can be stated more generally: How does one implement the core logic of a user interface design desired for a user-operated device?

Given the ever-increasing popularity of user-operated devices, particularly ones that are hosted by other devices, there is great interest in creating a device that includes the entire technology required for supporting an appropriate user interface for the device. Such a device includes a mechanism for generically mating to a variety of host devices. As a result, it would contain all of the logic necessary for supporting a desired user interface, and only rely on primitive services from a given hosting device to which it is presently connected. The present invention fulfills this and other needs.

### GLOSSARY

The following definitions are offered for purposes of illustration, not limitation, in order to assist with understanding the discussion that follows.

API: Abbreviation of application program interface, a set of routines, protocols, and tools for building software applications.

Bitmapped graphics: Refers to hardware and software that represent graphics images as raster images (e.g., in memory, and on-screen).

Event: Any action or occurrence detected by a program or device. Events can be user actions, such as clicking a mouse button or pressing a key, or system occurrences, such as running out of memory.

Protocol: An agreed-upon format for transmitting data between devices.

User interface (UI): The mechanism allowing a user to interface with a program or device. An interface includes a set of inputs (e.g., commands, menus, or the like) through which a user communicates with the program or device, and includes a set of outputs (e.g., LEDs, icons, bitmap graphics, sound output, or the like) through which the program in turn communicates with the user.

### SUMMARY OF THE INVENTION

The present invention provides an “on-board” user interface system that allows a user interface of a first device to be supported at least in part by a second device. In an exemplary embodiment, the system comprises a module for generating at least one high-level event message indicating that an event has occurred that is relevant to the first device; a mapper for mapping the at least one high-level message into at least one lower-level message for controlling one or more hardware elements controlled by the second device; and a module for communicating the at least one lower-level message to the second device, such that the second device may activate one or more hardware elements that are appropriate for the event that has occurred.

A method of the present invention for allowing a user interface of a first device to be hosted by a second device may be summarized as follows. First, a notification is received at the first device indicating that an event has occurred that is relevant to the first device. Next, at least one abstract message is generated for indicating that the event has occurred. Based on the (at least one) abstract message, at least one message is transmitted to the second device, the message(s) intended for activating at least one particular user interface element on the second device. Finally, in response to the (at least one) message transmitted to the second device, at least one particular user interface element on the second device is activated.

### BRIEF DESCRIPTION OF THE DRAWINGS

FIG. 1A is a block diagram illustrating a basic media capturing and recording system suitable for implementing a portion of the present invention pertaining to initial media capture (e.g., capture of digital media), which then may be transmitted to a host system (e.g., computer system) using wireless or wire-line technique.

FIG. 1B is a very general block diagram of an IBM-compatible system, which is adapted to include portions of the distributed image processing of the present invention.

FIG. 2 is a block diagram of a computer software system for directing the operation of the computer system of FIG. 1B.

FIG. 3A is a block diagram illustrating a “Class A” device.

FIG. 3B is a block diagram illustrating a “Class B” device.

FIG. 3C is a block diagram illustrating a “Class C” device.

FIG. 4 is a flowchart illustrating operation of the present invention.

### DETAILED DESCRIPTION OF A PREFERRED EMBODIMENT

The following description will focus on the presently preferred embodiment of the present invention, which operates in an environment typically including a variety of computing or information-storing devices (e.g., desktop computers, server computers, and portable computing devices) that are capable of hosting other devices (e.g., digital camera) via a temporary or permanent connection. In particular, the following description focuses on an embodiment of the present invention in a digital camera device, the currently-preferred embodiment, which may be occasionally connected to a multitude of different “host” devices, such as a Palm™ handheld computer or a cellular phone. However, those skilled in the art will appreciate that the present invention may be embodied in practically any device that is intended to be connected to another device (or devices). Further, the description focuses on implementation of portions of the invention in a connected environment including computers, such as an IBM-compatible computer running under Microsoft® Windows XP, with Internet support. The present invention, however, is not limited to any particular one application or any particular environment. Instead, those skilled in the art will find that the system and methods of the present invention may be advantageously embodied on a variety of different platforms, including Macintosh, Linux, BeOS, Solaris, UNIX, NextStep, and the like, as well as special-purpose operating systems (e.g., digital camera operating systems). Therefore, the description of the exemplary embodiments that follows is for purposes of illustration and not limitation.

I. Basic System

A. Digital Camera Hardware

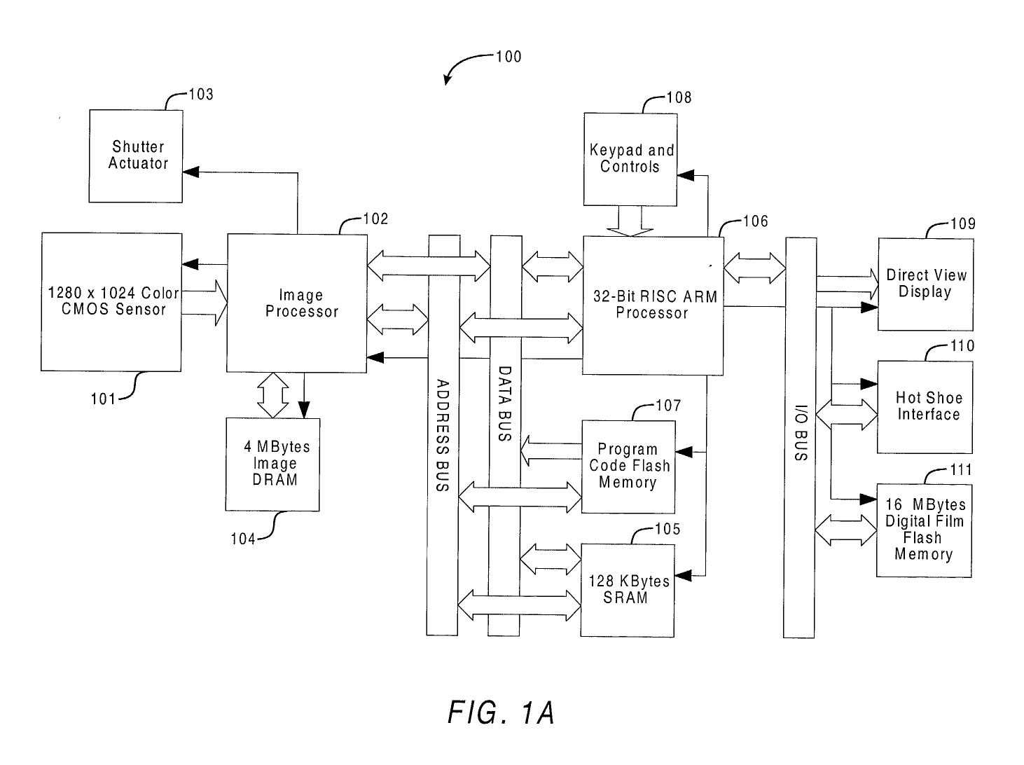

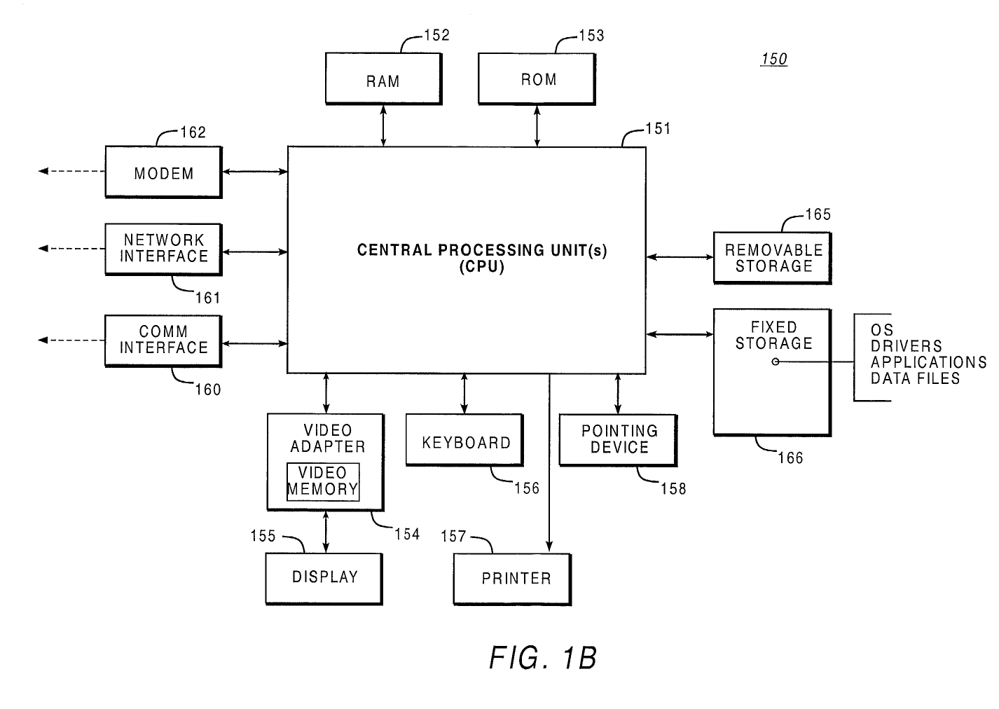

FIG. 1A is a block diagram illustrating a basic media capturing and recording system 100 suitable for implementing a portion of the present invention pertaining to initial media capture (e.g., capture of digital media), which then may be transmitted to a host system (e.g., computer system) using wireless or wire-line technique. For purposes of illustration, the following will focus on implementation of the system 100 as a digital camera. However, as noted above, for purposes of implementing the methodology of the present invention, the system 100 may also be implemented in a variety of other devices that would benefit from hosted connectivity to other devices.

As shown in FIG. 1A, the system 100 includes a Sensor 101, a Shutter Actuator 103, an Image Processor 102, an Image (DRAM) Memory 104, a (Central) Processor 106, a Keypad and Controls 108, a Program Code Flash Memory 107, a (System) Memory 105, a Direct View Display or Viewfinder 109, a Hot Shoe Interface 110, and a “Digital Film” Flash Memory 111. As illustrated, these various components communicate with one another using a bus architecture including, for instance, an Address Bus, a Data Bus, and an I/O (Input/Output) Bus.

The system 100 employs the Sensor 101 for basic image capture. The Sensor 101 operates, in essence, by capturing light and transforming that into electrical voltage levels. A suitable sensor is available from a variety of vendors, including VLSI Vision, Motorola, and Toshiba. In a preferred embodiment, the Sensor 101 includes, for example, a 1280×1024 color CMOS sensor, such as a VLSI Vision VVL 6801 CMOS sensor. However, other sensor technology is suitable, including CCD sensors.

The Sensor 101 must, of course, be part of a larger assembly to operate. Specifically, the Sensor 101 operates in conjunction with a lens assembly (not shown), or other optics to focus an image onto the sensor. The optics themselves are controllable, for instance, using a conventional aperture, focus, and shutter control mechanisms. The currently preferred embodiment uses an 18 mm fixed-focal length, fixed-aperture lens assembly to provide a broad depth of field. The lens assembly employs two manual slide controls, a macro lens control, and an exposure control. The macro lens control switches from normal to close-up mode by sliding a macro lens in and out of the lens assembly to provide normal or extreme close-up capability. The exposure control switches from normal to bright light by sliding a neutral gray filter in and out of the lens assembly. Aside from choosing normal or bright light, normal or close-up mode, the camera requires no manual focusing, shutter speed, or aperture adjustment. Operation is as simple as point and shoot. The Sensor 101, on the other hand, operates under the control of the Image Processor 102, which will now be described.

The Image Processor 102, which basically operates as a state machine, provides overall control for the Sensor 101. In operation, the Image Processor 102 controls the Sensor 101 by, in effect, telling it what to do and when. For instance, the Image Processor 102 issues timing signals to the Sensor 101 for indicating how the Sensor 101 should record and stream out image data. Further, the Image Processor 102 provides general Input/Output (I/O) control that allows one to coordinate control of the sensor with other electromechanical peripherals, such as a shutter, lens aperture, or the like.

Actual implementation of the Image Processor 102 itself may be accomplished in a variety of different ways. For a microprocessor-based implementation, for instance, the Image Processor 102 may be implemented as a microprocessor (e.g., PowerPC 823 microprocessor, available from Motorola, Inc. of Schaumburg, Ill.) with DSP (digital signal processing) logic blocks, memory control logic blocks, video control logic blocks, and interface logic. Alternatively, the Image Processor 102 may be implemented as a “camera on a chip (set)” using, for instance, a Sierra Imaging Raptor I or II chipset (available from Sierra Imaging, Inc. of Scotts Valley, Calif.), a Sound Vision Clarity 1 or 2 chipset (available from Sound Vision, Inc. of Framingham, Mass.), or similar chipset that integrates a processing core with image processing periphery. In a preferred embodiment, the Image Processor 102 preferably supports hardware implementation of a wavelet-transform engine complete with a wavelet-transform filter bank, so that the wavelet-transform process may be pipelined through a series of dedicated hardware gates (instead of executed as a sequence of software instructions repeatedly loaded and processed by a general-purpose microprocessor).

The Image Processor 102 is not a stand-alone part but, instead, relies on the (Central) Processor 106 for control instructions. The Image Processor 102 sits on the Address and Data Buses and is accessible by the Processor 106 through a series of registers. In this manner, the Processor 106 may instruct the Image Processor 102 what to perform and when. For instance, the Processor 106 may instruct the Image Processor 102 to turn on the Sensor 101, to capture an image at the Sensor 101, and to execute the wavelet transform. Therefore, the Image Processor 102 is very much a facilitator but is not in and of itself a controller for the system.

The Shutter Actuator 103 is a simple, generic component for controlling light exposure on the Sensor 101. Depending on the behavior of the actual sensor employed, the Shutter Actuator 103 may not even be necessary. In particular, the Shutter Actuator 103 is employed in those instances where the Sensor 101 requires a black reference. In such an embodiment, the Shutter Actuator 103 is an electromechanical interface coupled to a solenoid which, when the interface responds to a particular logic level, triggers an open/close cycle of a mechanical shutter. The mechanical shutter, which serves to selectively block light entering the lens assembly of the camera, may be of a conventional design available from a variety of suppliers. A suitable supplier includes, for instance, Sunex, Inc. of Carlsbad, Calif.

The Image Memory (DRAM) 104 serves to store the image captured from the Sensor 101. The Sensor 101 itself does not “store” the image that it captures. Therefore, the Image Memory 104 is an image-capture and in-place transform (frame) buffer. This memory is controlled by the Image Processor 102 and can be shut off when not in use for power-saving purposes. During basic operation of the camera, the captured image is transferred directly into the Image Memory 104, using a sample/transfer technique. In order to make this efficient, the process is controlled by the Image Processor 102 in a manner somewhat akin to DMA (direct memory access) transfer employed on desktop computers. Here, the Image Processor 102 functions as a state machine which simply samples and transfers information from the Sensor 101 to the Image Memory 104. In the presently preferred embodiment, the Image Memory 104 comprises conventional DRAM (dynamic random-access memory) memory available from a variety of vendors, including, for instance, Toshiba, Micron, Hitachi, Samsung, and others. A size of about 4 MB (megabyte) or more is suitable for this component.

The next several components discussed, which may be viewed as components hanging off of the Address and Data Buses of the Processor 106, are typical components that one would ordinarily expect to find when implementing a data processing device; collectively, these components may be viewed as a computer embedded in the camera. For example, these components include the previously mentioned general-purpose microprocessor (Processor 106) coupled to memory (System Memory 105 and Program Code Flash Memory 107). The Working or System Memory 105 is the general working or scratchpad memory for the Processor 106. This memory is used for storing program-created variables, stacks, heap(s), and the like. In the presently preferred embodiment, the System Memory 105 comprises static RAM (e.g., SRAM), which is also available from a variety of vendors. A size of about 128 KB (kilobyte) or more is suitable for this purpose. The Program Code Flash Memory 107, on the other hand, comprises 1 MB of directly-addressable flash storage that holds the operating system and embedded software, that is, the program code comprising the instructions that the processor must execute to operate. The flash memory, which may be conventional flash memory that is available from a variety of vendors, need not be of the removable type, as the Program Code Flash Memory 107 is not intended to be removed from the system by the camera user.

The Processor 106 itself, in the presently preferred embodiment, comprises a 32-bit RISC ARM Processor designed by ARM Limited of Maidenhead, UK. ARM licenses its designs to semiconductor partners for manufacture, supply, and support; for a list of ARM licensees, see e.g., http://www.ann.com/Partners/. The ARM processor has an efficient instruction set that is ideal for performing cyclical functions quite rapidly and includes sufficient bandwidth for transferring large amounts of data quickly (e.g., for performing Huffman coding on a large amount of data). Additionally, the processor is a dedicated processor, without the overhead of a substantial number of peripherals. These features make the processor attractive for use in a digital camera embodiment.

For a camera embodiment, the client device may include its own interface that is capable of receiving input from users and/or may share these elements with a hosting device (e.g., PDA) as described below. Keypad and Controls 108 are conventional inputs that support user input. Similarly, the Direct View Display (“Viewfinder”) 109 is a direct view LCD (liquid crystal display) that provides feedback to the user or camera operator. During photography mode, the Viewfinder 109 replaces the plastic viewfinders and LCD panels found on most digital cameras and provides the most accurate real-time representation of the scene visualized by the sensor. The Viewfinder 109 overlays simple icons onto the image to indicate the status of various camera settings. The Viewfinder 109 fits inside an eyepiece which keeps sunlight out and allows the operator to visualize the scene in any lighting conditions. During preview mode, the Viewfinder 109 shows previews of the captured photos and allows the operator to delete unwanted photos or tag photos for wireless transmission. Thus for a camera embodiment, the Viewfinder 109 is used to provide a representation of the image that is being captured, in preview and/or post-capture fashion.

In order to provide the display image to the Viewfinder 109, the Sensor 101 is subsampled at a rate to create a version of the image appropriate for display. During preview processing, the system continuously captures the sensor mosaic and sub-samples the resulting mosaic for preview purposes. A histogram of the sampled luminosity is fed into a “linearization” filter to produce a balanced dynamic range for best optical perception. The scaled and “linearized” image is then displayed on the viewfinder module. The histogram data is then adjusted to match the preview image for use in linearizing the next image. The cycle is repeated continuously to provide a real-time viewfinder mechanism. The Viewfinder 109 itself typically operates in conjunction with a display controller and a frame buffer (not shown), both of which may be integrated within the display component itself.

Both the Keypad and Controls and Direct View Display components, which may be conventional in nature, interface directly with the Processor 106 through general I/O (e.g., I/O Bus). Typically, such devices communicate with the microprocessor through means of interrupt requests (IRQ). Both the Keypad and Controls and Direct View Display components are available from a variety of vendors. Examples include Sharp, Toshiba, and Citizen of Japan, Samsung of South Korea, and Hewlett-Packard of Palo Alto, Calif. More customized displays are available from Displaytech, Inc. of Longmont, Colo. For an embodiment that does not need to interact with users, such as a surveillance camera, the foregoing components may be eliminated.

Additionally for a camera embodiment, it is desirable for the device to include an interface for standard peripheral devices, such as a detachable flash device. This may be provided by Hot Shoe (Accessory) Interface 110, which is a general I/O port that may comprise a serial interface of a conventional design that the camera uses to interface to its accessories via the Hot Shoe Interface. In this manner, a flash accessory can be clipped onto the camera via the Hot Shoe Interface for added illumination.

The Hot Shoe Interface 110 combines a Serial Peripheral Interface (SPI) with a multiplexed I/O bus which provides a plug-and-play interface to a family of accessories. These accessories may include, in addition to a flash unit, a wireless holster for cellular phones (e.g., available from Motorola, Nokia, Ericsson, and Samsung), extra film backs for compatibility with format digital film (e.g., Sony Memory Stick or SmartMedia), a USB cradle, an RJ-11 modem cradle, a wireless cellular module, extender cables, and the like. In the currently-preferred embodiment, the interface is based on the I2C-standard serial interface, which supports logic allowing the device to sense I2C-compatible devices that are attached to the port. I2C, which stands for Inter IC Communication, is a serial bi-directional communication protocol created by Philips Semiconductor (subsidiary of Philips Electronics, based in The Netherlands) and is used for communication between integrated circuits. Most systems have one master and several slaves that communicate using only two wires. Every device has its own identification code. If that code is sent by the master only that device will respond with an acknowledgement. After the acknowledgement, the data to be communicated is sent or received by the master. Further information about the I2C communication protocol is available from Philips Electronics of The Netherlands. As with the Keypad and Controls 108 and Direct View Display or Viewfinder 109, the Hot Shoe Interface 110 itself is not required for implementing the image capturing and processing methodology of the present invention. In the specific embodiment of a consumer product such as a camera, though, these components typically would be included.

The system includes Digital Film Flash Memory 111, which serves as the “digital film” for the system for storing compressed images. The Flash Memory 111 may comprise available flash memory removable media, such as CompactFlash, DataFlash, and Sony Memory Stick, typically in a 16 MB or larger size. Available vendors for flash memory include, for example, SanDisk of Sunnyvale, Calif. or Sony of Japan. Alternatively, the Flash Memory 111 may be affixed directly (i.e., non-removable) to the system 100. In such an embodiment, the additional bulk associated with a removable media cartridge holder and its accompanying interface may be avoided. Those skilled in the art will appreciate that the system 100 may incorporate other non-volatile memory configurations and designs that readily accommodate the image capture and processing methodology of the present invention. In general, for a consumer device embodiment, one should choose media that accommodates on the order of 100 compressed images or more.

The camera embodiment is powered by a single CR-123 lithium battery (not shown), provided with instant-on capability. Due in part to the distributed image processing approach of the present invention (presented below), the camera has significant power savings over other camera designs. This gives the device not only a size and weight advantage over other cameras but also a battery life advantage.

For connectivity, the system includes a wireless holster, a USB cradle, and a modem cradle. The wireless holster physically connects the camera to a cellular phone (e.g., Motorola StarTAC cellular phone) and interfaces the Hot Shoe Interface to the phone's external accessory plug. The camera can be easily pulled out of the holster for use and clipped back in for transmission. Detection of the holster and phone signal is automatic to allow for hands-free transmission and there is no risk of corruption due to interruption by either loss of signal or unclipping. The camera clips into the USB cradle through the Accessory Hot Shoe Interface 110 to provide rapid photo interchange to a personal computer equipped with a standard USB port. The USB cradle acts a USB slave device and therefore requires no batteries or power supply for operation and instead draws its power from the PC. The camera can also clip into a modem cradle through the Hot Shoe Interface. The modem cradle allows the camera to transmit images to the PhotoServer via a land line connection (e.g., 33.6 KBps) via a standard RJ-11 phone jack. The modem cradle is powered by the battery in the camera.

Further description of the system 100 may be found in the above-mentioned commonly-owned application Ser. No. 09/434,703 (Docket No. LS/0001.01). The above-described system 100 is presented for purposes of illustrating the basic hardware underlying a client device (e.g., wireless digital camera) that may be employed in the system of the present invention. The present invention, however, is not limited to just digital camera devices but, instead, may be advantageously applied to a variety of user-operated devices capable of participating and/or benefiting from the methodologies of the present invention presented in detail below.

B. Basic Computer Hardware for a Sample Host (e.g., Desktop Computer, Server Computer, or Other Computing Device)

Portions of the present invention may be implemented on a conventional or general-purpose computing device, such as an IBM-compatible personal computer (PC) or server computer that may host the above-described client (digital camera) device, such as via USB or RS-232 connectivity. FIG. 1B is a very general block diagram of an IBM-compatible system 150, which is adapted to include portions of the distributed image processing of the present invention. As shown, system 150 comprises a central processor unit(s) (CPU) 151 coupled to a random-access memory (RAM) 152, a read-only memory (ROM) 153, a keyboard 156, a pointing device 158, a display or video adapter 154 connected to a display device 155, a removable (mass) storage device 165 (e.g., floppy disk), a fixed (mass) storage device 166 (e.g., hard disk), a communication port(s) or interface(s) 160, a modem 162, and a network interface card (NIC) or controller 161 (e.g., Ethernet). Although not shown separately, a real-time system clock is included with the system 150, in a conventional manner.

CPU 151 comprises a processor of the Intel Pentium® family of microprocessors. However, any other suitable microprocessor or microcomputer may be utilized for implementing the present invention. The CPU 151 communicates with other components of the system via a bi-directional system bus (including any necessary I/O controller circuitry and other “glue” logic). The bus, which includes address lines for addressing system memory, provides data transfer between and among the various components. Description of Pentium-class microprocessors and their instruction set, bus architecture, and control lines is available from Intel Corporation of Santa Clara, Calif. Random-access memory 152 serves as the working memory for the CPU 151. In a typical configuration, RAM of sixteen megabytes or more is employed. More or less memory may be used without departing from the scope of the present invention. The read-only memory (ROM) 153 contains the basic input/output (I/O) system code (BIOS)—a set of low-level routines in the ROM that application programs and the operating systems can use to interact with the hardware, including reading characters from the keyboard, outputting characters to printers, and so forth.

Mass storage devices 165, 166 provide persistent storage on fixed and removable media, such as magnetic, optical or magnetic-optical storage systems, flash memory, or any other available mass storage technology. The mass storage may be shared on a network or it may be a dedicated mass storage. As shown in FIG. 1B, fixed storage 166 stores a body of program and data for directing operation of the computer system, including an operating system, user application programs, driver and other support files, as well as other data files of all sorts. Typically, the fixed storage 166 serves as the main hard disk for the system and stores system and application software.

In basic operation, program logic (including that which implements methodology of the present invention described below) is loaded from the storage device or mass (fixed) storage 166 into the main (RAM) memory 152, for execution by the CPU 151. During operation of the program logic, the system 150 accepts user input from a keyboard 156 and a pointing device 158, as well as speech-based input from a voice recognition system (not shown). The keyboard 156 permits selection of application programs, entry of keyboard-based input or data, and selection and manipulation of individual data objects displayed on the display device 155. Likewise, the pointing device 158, such as a mouse, track ball, pen device, or the like, permits selection and manipulation of objects on the display device 155. In this manner, these input devices support manual user input for any process running on the system.

The computer system displays text and/or graphic images and other data on the display device 155. Display device 155 is driven by the video adapter 154, which is interposed between the display device 155 and the system 150. The video adapter 154, which includes video memory accessible to the CPU, provides circuitry that converts pixel data stored in the video memory to a raster signal suitable for use by a cathode ray tube (CRT) raster or liquid crystal display (LCD) monitor. A hard copy of the displayed information, or other information within the system 150, may be obtained from the printer 157, or other output device. The printer 157 may include, for instance, an HP Laserjet® printer (available from Hewlett-Packard of Palo Alto, Calif.), for creating hard copy images of output of the system.

The system itself communicates with other devices (e.g., other computers) via the network interface card (NIC) 161 connected to a network (e.g., Ethernet network), and/or a modem 162 (e.g., 56K baud, ISDN, DSL, or cable modem), examples of which are available from 3Com of Santa Clara, Calif. The system 150 may also communicate with local occasionally-connected devices (e.g., serial cable-linked devices) via the communication (“comm”) interface 160, which may include an RS-232 serial port, a Universal Serial Bus (USB) interface, or the like. Devices that will be commonly-connected locally to the comm interface 160 include laptop computers, handheld organizers, digital cameras, and the like.

IBM-compatible personal computers and server computers are available from a variety of vendors. Representative vendors include Dell Computers of Round Rock, Tex., Compaq Computers of Houston, Tex., and IBM of Armonk, N.Y. Other suitable computers include Apple-compatible computers (e.g., Macintosh), which are available from Apple Computer of Cupertino, Calif., and Sun Solaris workstations, which are available from Sun Microsystems of Mountain View, Calif.

As in the case of the example client device (i.e., system 100), the above-described system 150 is presented for purposes of illustrating the basic hardware underlying desktop and server computer components that may be employed in the system of the present invention. For purposes of discussion, the following description will present examples in which it will be assumed that there exists a “server” (e.g., Web server) that communicates with one or more “clients” (e.g., media-capturing devices). The present invention, however, is not limited to any particular environment or device configuration. In particular, a client/server distinction is not necessary to the invention, but is used to provide a framework for discussion. Instead, the present invention may be implemented in any type of system architecture or processing environment capable of supporting the methodologies of the present invention presented in detail below.

C. Basic System Software

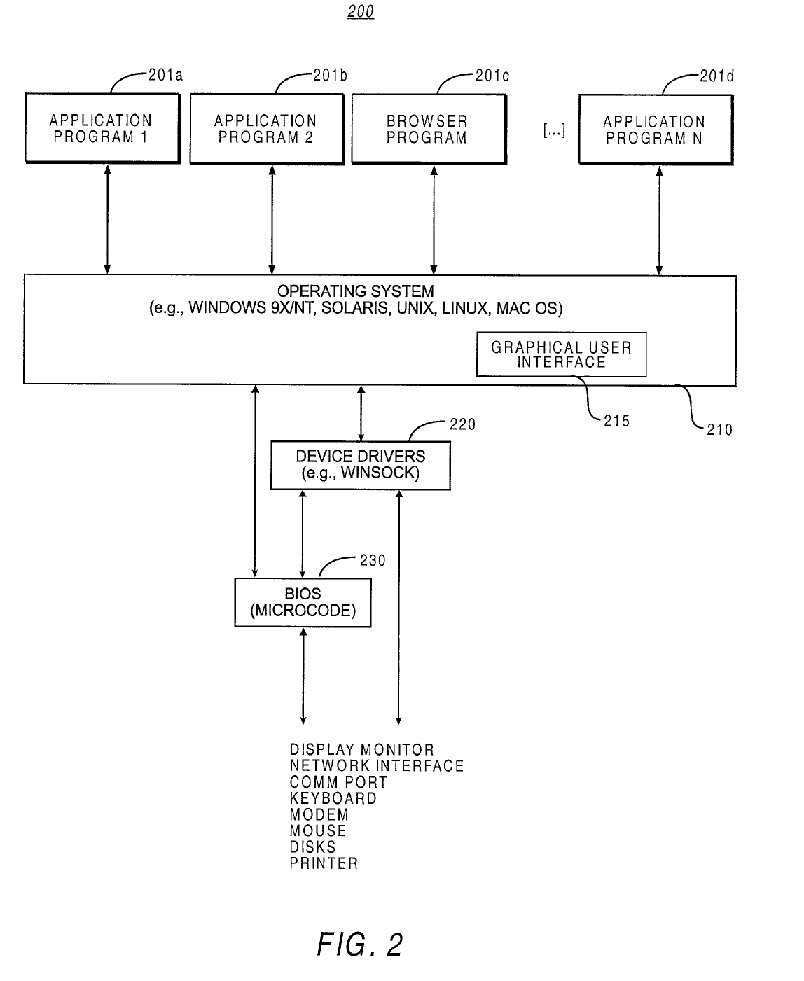

Illustrated in FIG. 2, a computer software system 200 is provided for directing the operation of the computer system 150. Software system 200, which is stored in system memory (RAM) 152 and on fixed storage (e.g., hard disk) 166, includes a kernel or operating system (OS) 210. The OS 210 manages low-level aspects of computer operation, including managing execution of processes, memory allocation, file input and output (I/O), and device I/O. One or more application programs, such as client application software or “programs” 201 (e.g., 201a, 201b, 201c, 201d), including browser and image processing software, may be “loaded” (i.e., transferred from fixed storage 166 into random-access memory 152) for execution by the system 150.

Software system 200 includes a graphical user interface (GUI) 215, for receiving user commands and data in a graphical (e.g., “point-and-click”) fashion. These inputs, in turn, may be acted upon by the system 100 in accordance with instructions from operating system 210 and/or client application module(s) 201. The GUI 215 also serves to display the results of operation from the OS 210 and application(s) 201, whereupon the user may supply additional inputs or terminate the session. Typically, the OS 210 operates in conjunction with device drivers 220 (e.g., “Winsock” driver—Windows' implementation of a TCP/IP stack) and the system BIOS microcode 230 (i.e., ROM-based microcode), particularly when interfacing with peripheral devices. OS 210 can be provided by a conventional operating system, such as Microsoft® Windows 9x, Microsoft® Windows NT, Microsoft® Windows 2000, or Microsoft® Windows XP, all available from Microsoft Corporation of Redmond, Wash. Alternatively, OS 210 can also be an alternative operating system, such as the previously-mentioned operating systems.

The above-described hardware and software are presented for purposes of illustrating the basic underlying components that may be employed for implementing “client” and “host” portions of the present invention. For purposes of discussion, the following description will present examples in which it will be assumed that there exists a “host” (e.g., PDA, PC, server, microprocessor-enabled cell phone, or the like) that communicates with a “client,” such as wireless or wire-line digital camera devices or other client (i.e., user-operated) device. The present invention, however, is not limited to any particular environment or device configuration. In particular, a client/host or hosted/hosting distinction is not necessary to the invention, but is used to provide a framework for discussion. Instead, the present invention may be implemented in any type of system architecture or processing environment capable of supporting the methodologies of the present invention presented in detail below.

II. System and Methodology Providing On-Board User Interface

A. Overview

1. General

In accordance with the present invention, an “on-board” user interface mechanism is provided. The complete user interface logic, which is “on-board” the client or hosted device, is brought to the hosting device. In the currently preferred embodiment, all of the logic of the user interface (i.e., operator-based mechanism) of the client device is on-board the client, regardless of whether individual portions of the logic entail implementation-specific physical details. This includes both the “logical” user interface (i.e., separate from physical implementation) as well as the “physical” user interface. Since all of the logic necessary to implement a user interface resides “on-board” the client device, the hosting device need only provide a comparatively minor set of low-level features upon which the hosted device's user interface may be implemented.

Client or “hosted” devices, such as clip-on cameras and embeddable camera modules, are attached to or embedded in various devices, such as cellular telephones, PDAs, and computers, that provide varying levels of user interface features. The present invention includes a user interface support service that provides generic access to the user interface features provided by the combination of a hosted or client device (e.g., camera) with a hosting device (e.g., wireless device). A service module, UiServices, executes in the client device (e.g., camera), providing implementation-independent access to the user interface features, and is used by another client-side module, the OnBoardUi module, for interaction with the user.

2. OnBoardUi and UiServices Modules

The OnBoardUi module serves as a state machine that implements the actual “behavior” of the user-perceived interface. When a camera is connected to a hosting device, the user's interaction with the camera is determined by the combination of user interface support provided by the hosting device and the camera. The user interface capabilities of the hosting device that are accessible to the camera may be limited to none or may include some combination of support for access to buttons, buzzer, indicators, display screen, speaker, microphone, and event notification. The camera itself may provide a similar set of user interface capabilities. This collection of user interface capabilities is made available to the camera, in particular the OnBoardUi module within the camera, in a consistent manner.

User interface services or UiServices provides a means of a) discovering the set of user interface features that are available for use by OnBoardUi module and b) fully exploiting those features for providing a rich interface. For a particular camera and hosting device scenario, specific features may actually be supported by the hosting device, the camera, or “synthesized” by low-level software in the implementation of the UiServices API itself. For example, consider the case of a display-free camera (i.e., without an on-camera display screen) that is connected to a hosting device with a display screen that supports only the display of bitmaps: The UiServices implementation may provide support for display of menus and message boxes, as well as on-screen buttons. In another case, if the hosting device provides “native” support for menus and message boxes, the UiServices may simply wrap that support. Consider yet another scenario, where the hosting device may provide no such display screen support but such support is available on a display on the camera itself: In this case, the UiServices would provide a high-level wrapper around the camera's support.

The UiServices module defines an API for use by the client-side OnBoardUi module to implement the desired external behavior/interaction between the device(s) and the user. The OnBoardUi module provides a state machine that implements the actual user-perceived interface. In a digital camera embodiment, for example, other camera software modules send messages to the OnBoardUi module to change the user interface state when tasks are completed. For instance, when uploading is complete, the OnBoardUi module is informed so that it can change into an appropriate internal idle state, and then employ the UiServices API to cause this state transition to be reflected in the externally-visible interface features. Alternatively, a user action may be detected via the UiServices API, affecting the state of the OnBoardUi module and other modules in the camera device. For example, when the user pushes the “shutter button” in a camera embodiment, the OnBoardUi detects this using the services of the UiServices API, and then, if in the proper state (e.g., “able to take another picture” state) directs the camera software module (LsCamera, in a preferred embodiment) to capture an image. If appropriate for the chosen external user interface design, the OnBoardUi employs the UiServices to provide external visible/audible feedback to the user. In this example, LsCamera is a conceptual client-side module for directly interfacing with the client device; the module is actually composed of a collection of modules that provide media capture, media storage, memory management, and power management services for the camera device.

B. Classes of U Support

The user interface services provided by a hosting device may range from nothing (i.e., no services whatsoever provided) to elaborate built-in access surfaced to hosted devices for accessing complex user interface elements of the hosting device. Therefore, it is helpful to devise a mechanism that classifies the level of UI support provided by a particular hosting device. In accordance with the present invention, a “class” of UI support broadly defines what can be done in terms of UI interaction and applies to the hosting device, the client device, and the combination of the two. UI support by each of the classes defined below can be extended to include recording of sound (RS) and voice commands (VC). VC should be considered a superset of RS functionality. For example, a Class A hosting device which supports voice commands should be labeled as “Class AVC” and supports both sound recording and voice commands.

In the currently preferred embodiment, three classes of hosting devices may be supported, as will next be described. However, those skilled in the art will appreciate that a variety of different classes of devices may be defined in accordance with the approach described herein.

1. Class A

For Class A devices, no host services are provided except for power (with perhaps some silent connectivity). The hosting device does not provide the attached client device (e.g., camera device) any access to the hosting device's user interface features. For these devices, the user interface is limited to button interaction, display of states via indicators such as LEDs, and playing of sounds with a buzzer.

2. Class B

For Class B devices, the host has a standard, prebuilt way of providing access to primitive user interface elements (e.g., buttons, screens, and/or icons) of the host. In some Class B scenarios, the hosting device vendor may provide limited new API support for user interface features for hosted devices. In addition to features provided by Class A, Class B devices include a bitmap display and/or keyboard/button features available on the hosting device that may be accessed by the client device through some communication mechanism provided by the host.

3. Class C

Class C devices allow the installation of at least relatively minor software or drivers on the host that may serve as a proxy for allowing access to the host's user interface elements. Thus, the host allows the installation of software that provides a bridge to the host's primitive graphic and/or user input/output elements (e.g., buttons, screens, and the like). In addition to features available to Class B devices, Class C devices typically include a bitmap display large enough to display menus and message boxes. The hosting device vendor may provide substantial new user interface feature API support for hosted devices. This API support may be provided either through the accessibility of the non-trivial UI features on the host, through some exported protocol, and/or through actual revision of the hosting device for the inclusion of hosted device-provided software that runs on the host.

C. Modeling UI Complexity

The actual complexity of the externally visible interface presented to the user is an independent dimension from the class of hardware user interface features/capabilities discussed above. It is instructive to understand this separate dimension of product environment definition. An overly complex, difficult to use interface may be presented to the user if the set of user input/output features is inadequate for the complexity of the task the user needs to perform. Similarly, an overly complex interface will result if a more complex set of interface features is used when a simpler set would suffice. For example, in a Class A scenario, the button interaction could be as simple as “press a button get action A” or as complicated as “press the specified set of buttons in the specified order at the specified tempo to get action A”. The more complicated version may result because the set of selectable actions is larger than the set of buttons.

Similarly, in a Class C scenario, both the camera and the host device could have buttons, LEDs, buzzers, and display screens. If the camera has four buttons and there are only four selectable actions, then forcing the user to bring up a menu on the display and select an action is probably more complex/difficult to use than pressing a button. In this case, use of the display feature has added user interface complexity without adding functionality. On the other hand, using the display to show the last photo taken does increase functionality without unnecessarily increasing complexity.

D. Architecture

1. General

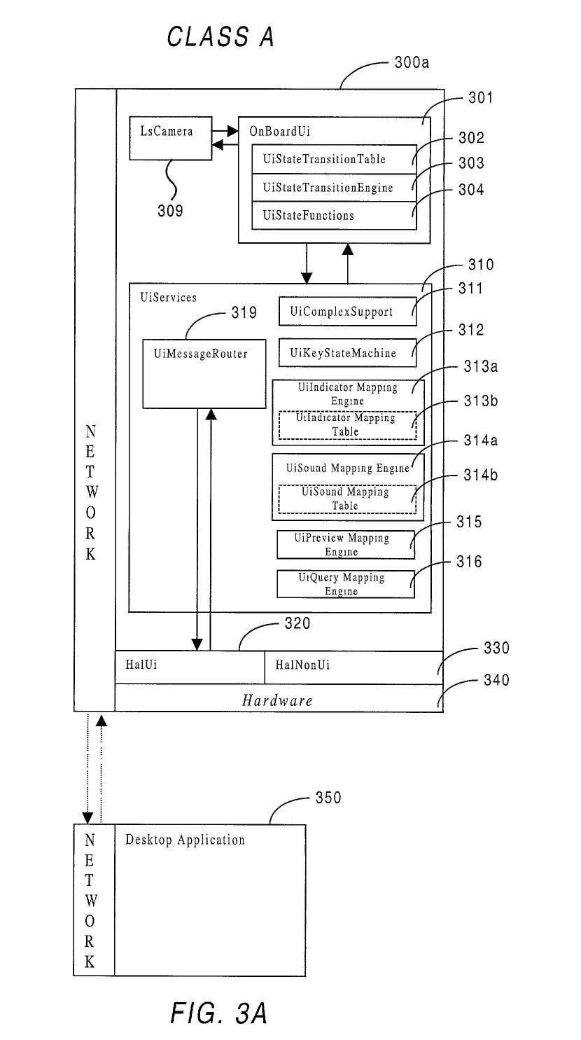

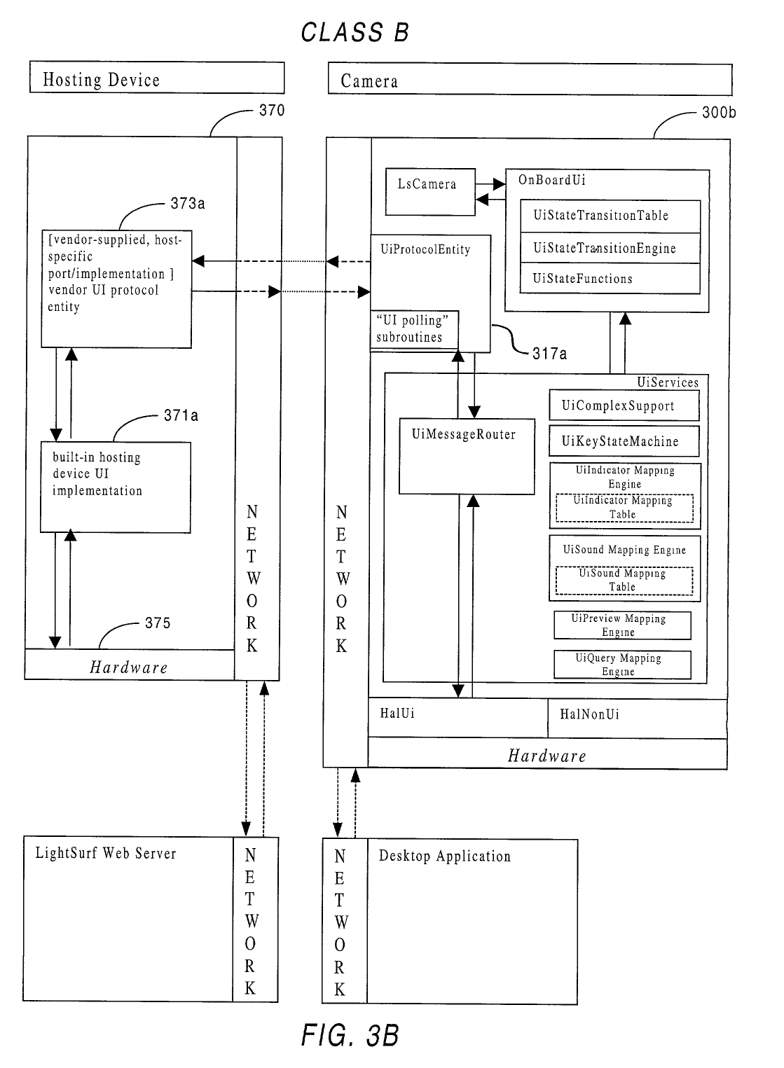

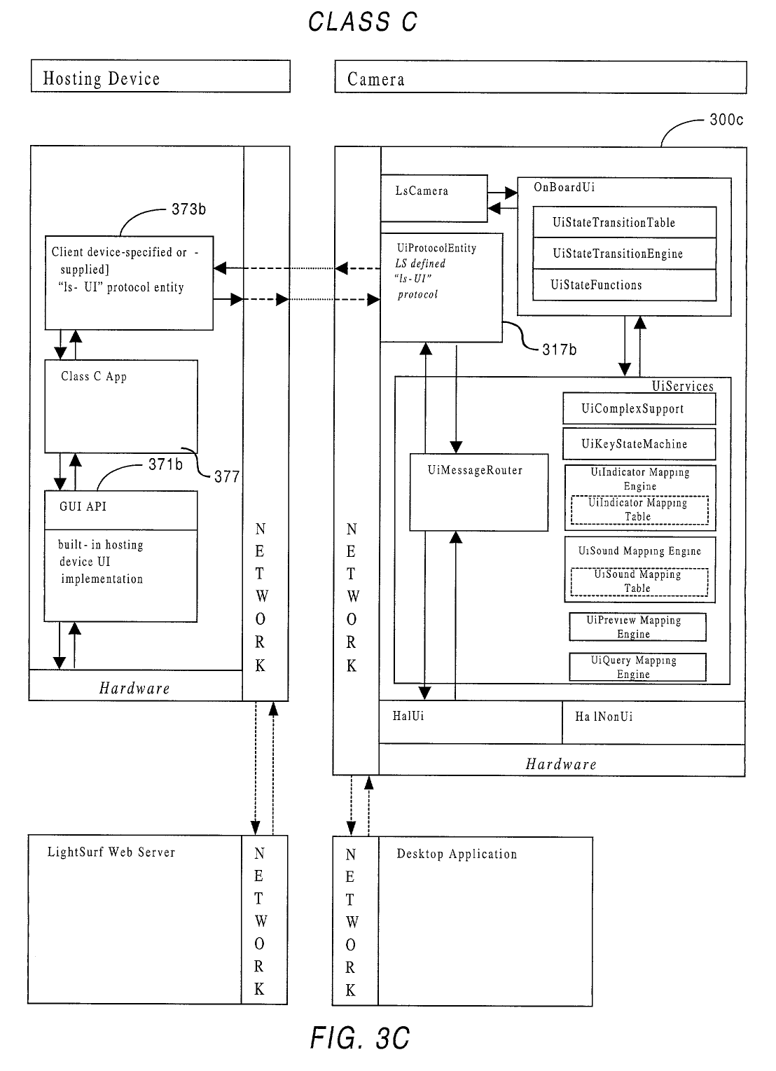

FIGS. 3A-C are high-level block diagrams illustrating system interaction among the various classes of devices, Classes A, B, and C, respectively. The diagrams demonstrate the relationship between the various modules that comprise the on-board interface.

2. Class A devices

FIG. 3A illustrates a Class A device. At a high level, Class A device 300a comprises a user-operated device that is self-hosted (i.e., supports its own user interface). However, the device may include some connectivity to other devices, such as Internet connectivity to another computer 350 operating applications software. As shown, Class A device 300a itself may be viewed as comprising the following high-level modules: device (LsCamera) module 309, on-board UI (OnBoardUi) module 301, UI services (UIServices) module 310, hardware module 340, non-UI hardware abstraction layer (HalNonUi) module 330, and UI hardware abstraction layer (HalUi) module 320. These modules will now be described in further detail.

a) UiServices Module

The UiServices module 310 provides an interface (API) by which the other major modules of the on-board interface state machine run. It encapsulates implementation specific user interface support. The external user interface elements/features available on the client or hosting device's hardware, when present, are wrapped by the UiServices module 310 as are presentation details. Therefore, the module encapsulates low-level routines that allow access to user interface hardware, perform mapping between actual and logical events, perform presentation composition, control data mapping, and also provide a means for interfacing with a communications mechanism that accesses the primitives surfaced by the hosting device. The UiServices module 310 includes the following major support components that help it accomplish its mission of abstracting user interface support.

(1) UiComplexSupport

UiComplexSupport module 311 provides the abstract support necessary to create, display, and manage complex GUI objects. These objects include menus, dialog boxes, soft keys, message boxes, and the like.

(2) UiKeyStateMachine (Implementation Specific)

UiKeyStateMachine module 312 is an implementation-specific state machine that maps keypad actions to logical actions or text characters. When UiServices module 310 receives a keypress event, the keypress handler examines the current input state to determine whether the keypress should be ignored or mapped. If the keypress should be mapped, an implementation-specific mapping function is called. The mapping performed is dependent on the current input state and the implementation-specific identifier of the key. If the current input state is a command state, a logical user command will be broadcast and handled by OnBoardUi module 301. If the current input state is a data entry state, a user data event will be broadcast and handled by the appropriate UiServices module 310 user data event handler. The mapping may be accomplished via a mapping table, mapping state machine, or procedurally as appropriate for the complexity of the mapping for the specific implementation. For example, in some implementations multiple timed key presses may be required to produce a single user command. In such a case, a mapping state machine may be more appropriate than a mapping table.

(3) UiIndicatorMappingTable (Implementation Specific)

UiIndicatorMappingTable module 313b is an implementation specific table that maps logical indicators to hardware or soft indicators. Hardware indicators may be, for example, LEDs located on the host or the camera. Soft indicators may be, for example, “soft” (i.e., simulated) LEDs or other bitmap information presented on a display or viewfinder located on the host or the camera. Such a table may be accessed by the UiIndicatorMappingEngine module 313a if the specific implementation is such that a table based approach is best.

(4) UiSoundMappingTable (Implementation Specific)

UiSoundMappingTable module 314b is an implementation specific table that maps logical sounds used to indicate user interface state transitions to sound implementations specific to a configuration. This table is accessed by the UiSoundMappingEngine module 314a when a table based mapping approach is best for the implementation.

(5) UiIndicatorMappingEngine (Implementation Specific)

The UiIndicatorMappingEngine module 313a performs the implementation specific mapping of logical indicator states to the hardware indicator states perceived by the user. This mapping may be entirely procedural or may be based on an implementation specific UiIndicatorMappingTable module 313b. For example, the logical indicator state “cameraBusy” may be mapped to one or more blinking LEDs cycling at a specific rate for a specific implementation.

(6) UiSoundMappingEngine (Implementation Specific)

The UiSoundMappingEngine module 314a performs the implementation specific mapping of logical sounds to the sounds perceived by the user. This mapping may be entirely procedural or may be based on an implementation specific UiSoundMappingTable module 314b. For example, the abstract sound “captureStill” may be mapped to a programmatically generated sound for a specific implementation.

(7) UiPreviewMappingEngine (Implementation Specific)

The UiPreviewMappingEngine module 315 performs the implementation specific mapping of a media preview request to the presentation the user actually receives. This includes obtaining the media from the media storage, composing the media as appropriate to the implementation's user interface design, controlling the conversion of the result to the appropriate data format for presentation on that implementation's hardware, and finally controlling the presentation of the final result.

(8) UiQueryMappingEngine (Implementation Specific)

The UiQueryMappingEngine module 316 performs the implementation specific mapping of logical user querys to the request presentations the user actually receives. This allows a single logical user query to be presented to the user in any manner consistent with the hardware capabilities and user interface design of the implementation.

(9) UiMessageRouter (Implementation Specific)

The UiMessageRouter module 319 encapsulates information and processing necessary to route user interface messages to the HalUi module 320 or the UiProtocolEntity module 317a or 317b in FIG. 3b. Therefore, UiMessageRouter module 319 determines whether hardware/software on the client or the host will be used to effect the action represented by a user interface message. The action may be a request for information or a request to present a change in the user interface hardware state that is observed by the user.

b) OnBoardUi Module

The OnBoardUi module 301 implements a state machine that embodies a desired user interface for the hosted device. Thus, the OnBoardUi module 301 provides a logical user interface for a particular device. For example, in the case of a digital camera, the OnBoardUi module 301 operates and manipulates the controls for the camera, which allows for the capture of digital images. The API of the UiServices module 310 defines the environment in which the OnBoardUi module 301 runs.

(1) UiStateTransitionTable

The UiStateTransitionTable module 302 contains the user interface state information necessary to drive the OnBoardUi module 301 state machine. The entries in this table encompass the possible user interface state transitions. Each entry identifies a start state, an end state, the identifier of a logical transition sound played when entering the end state, the logical indicator states associated with the end state, and a pointer to a state function that is executed when the end state is entered. The state function pointer may be NULL. In addition, each entry includes an attribute identifier and an associated value.

(2) UiStateTransitionEngine

The UiStateTransitionEngine module 303 is executed whenever a user or system-initiated event occurs that could result in a state transition and determines whether a transition should occur. If a transition occurs, it performs all generic state transition processing.

For each entry in the UiStateTransitionTable module 302 with a start state identifier equal to the current state identifier, the engine compares the attribute value specified in the table entry to the current value of the attribute. If the values match, a transition to the end state occurs and the engine sends a message to UiServices module 310 requesting that the states of the logical indicators be set to those specified in the table entry. It then sends a message to UiServices module 310 requesting that the logical transition sound should be played. Finally, it calls the state function if the pointer specified is not NULL.

(3) UiStateFunction

There is a UiStateFunction module 304 associated with each state function pointer in the UiStateTransitionTable module 302. A single function may be pointed to by more than one entry in the table if it supplies common functionality. Such a function performs processing specific to an individual state or common to a collection of states.

c) Hardware and Hardware Abstraction Modules

The client or hosted device 300a includes hardware 340. In the embodiment of a media capture device (e.g., digital camera), for example, the hardware 340 comprises a specialized, embedded microprocessor/computer controlling media capture hardware. The individual user interface features provided by hardware 340 on the hosted device (e.g., camera) are accessed by calls to a low-level hardware abstraction layer/user interface (HalUi) module 320, which are wrapped (i.e., abstracted) by UiServices 310. Interface to non-user interface hardware is provided through the HalNonUi (hardware abstraction layer/non-user interface) module 330. Thus, HalUi 320 affords access, at the hardware level, to various user interface elements (e.g., buttons, LEDs, iconic displays, and bitmap screens) that are present on the hosted device itself. HalNonUi 330 permits access to other (i.e., non-user interface) hardware of the hosted device 300.

3. Class B Devices

Class B devices, illustrated in FIG. 3B, include the same client-side modules as the above described Class A devices. In contrast to the Class A environment, however, the Class B environment includes a hosting device 370 with a hardware interface 375 to the device's underlying hardware. Therefore, in Class B devices, the following modifications/additions are contemplated.

As shown in FIG. 3B, the embodiment includes at a high level two devices: a host or “hosting” device 370 and a client or “hosted” device 300b. The two devices may be separate physical devices, or may be integrated (e.g., via a clip on mechanism). The hosting device 370 includes hardware 375, comprising various user interface elements including input (e.g., buttons or other user input means), user output/feedback (e.g., LEDs, LCD-based icons, or the like), and (typically) a screen supporting bitmap-addressable display. For controlling this user interface hardware, the hosting device 370 includes a built-in (hosting device) UI implementation module 371a. This module represents a framework for controlling/managing the device's user interface elements. For example, the hosting device's screen device may be partitioned such that the bottom of the screen displays iconic information while the middle of the screen comprises a bitmap-addressable portion of the display. Such hosting device-specific implementation logic allows the hosting device to have precise control over its user interface elements. That logic is encapsulated in the built-in UI implementation module 371a.

As shown in FIG. 3B, the hosting device 370 includes a built-in hosting device UI implementation 371a, which represents the device's built-in graphical user interface or UI API (e.g., proprietary or open standard) that the device manufacturer allows programming logic to access the device's user interface elements. The UI implementation 371a interfaces with a proxy, vendor-supplied UI protocol entity 373a, which interfaces with a corresponding client-side UI protocol entity (UiProtocolEntity) 317a. The vendor UI protocol entity 373a represents a vendor-supplied, host-specific implementation of a protocol, which allows third party access (under the vendor's design rules) to the hosting device hardware 375. Typically, access occurs over a communication link, such as a serial interface (e.g., RS 232, Universal Serial Bus (USB), or the like). Thus, the vendor UI protocol entity 373a allows an attached device (e.g., hosted device 300b) to invoke the primitives serviced by the hosting device's vendor. For example, using the vendor UI protocol entity 373a, the hosted device 300b may manipulate iconic information and bitmap information on the hosting device's screen. Additionally, the vendor UI protocol entity 373a allows the hosted device to receive notification about user input (including polling for such information) from the hosting device.

In Class B devices, the UiServices module only has access to hosting device UI features via the host device UI API, as it is exposed through some existing protocol defined by the host device manufacturer. This includes extensions to the host device protocol provided by the manufacturer specifically for a particular vendor's needs. However, Class B devices typically would not include executable code designed, specified and/or supplied by the particular vendor. When necessary based on the class of the hosting device, low level software subroutines in UiServices provide support for the creation and display of menus, message boxes, and other more advanced display objects. This might occur, for example, when the hosting device only provides the capability of displaying a bitmap and no explicit support for such widgets (i.e., a Class B host). In addition, low-level software in UiProtocolEntity module 317a provides support for user input event notification (via polling if necessary) for those configurations in which notification is not supported by the hosting device.

4. Class C Devices

Class C devices, illustrated in FIG. 3C, include a device 300c with the same client-side modules as the above-described Class B devices. In the Class C environment, however, the hosting device (now shown at 373b) includes a host-side Class C application 377. This is typically a small program, included at the time of manufacturer or later, that provides a mapping between the UI implementation (now, graphical user interface or GUI 371b) provided by the host device and a client device-supplied/specified protocol entity 373b. In contrast to the vendor-supplied protocol entity 373a in the Class B environment, the protocol entity 373b is client-supplied/specified, either at the time of manufacture or thereafter.

In the Class C environment, the client device UI protocol entity 317b is changed, when compared to that component in the Class B environment. It now implements the client device-defined protocol (as opposed to the hosting device-defined protocol). In that instance, the UiServices module uses the client device-defined protocol to manipulate the user interface elements on the hosting device. In the Class C environment, the client device defines the protocol and injects an application into the hosting device for supporting that client device-defined protocol.

E. Internal Operation

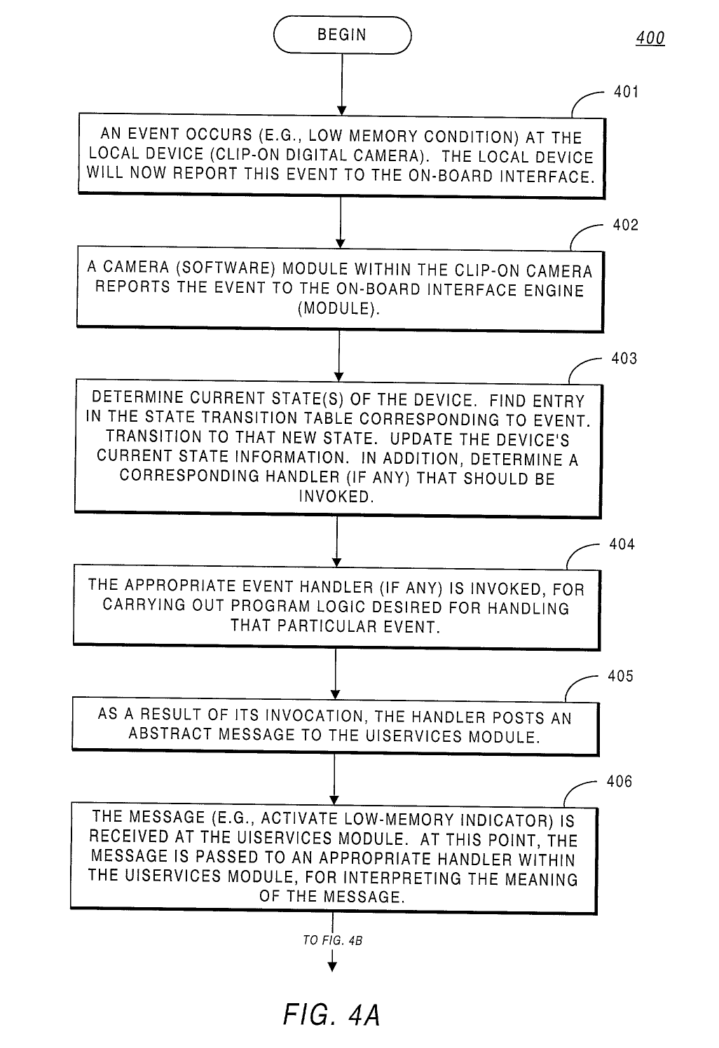

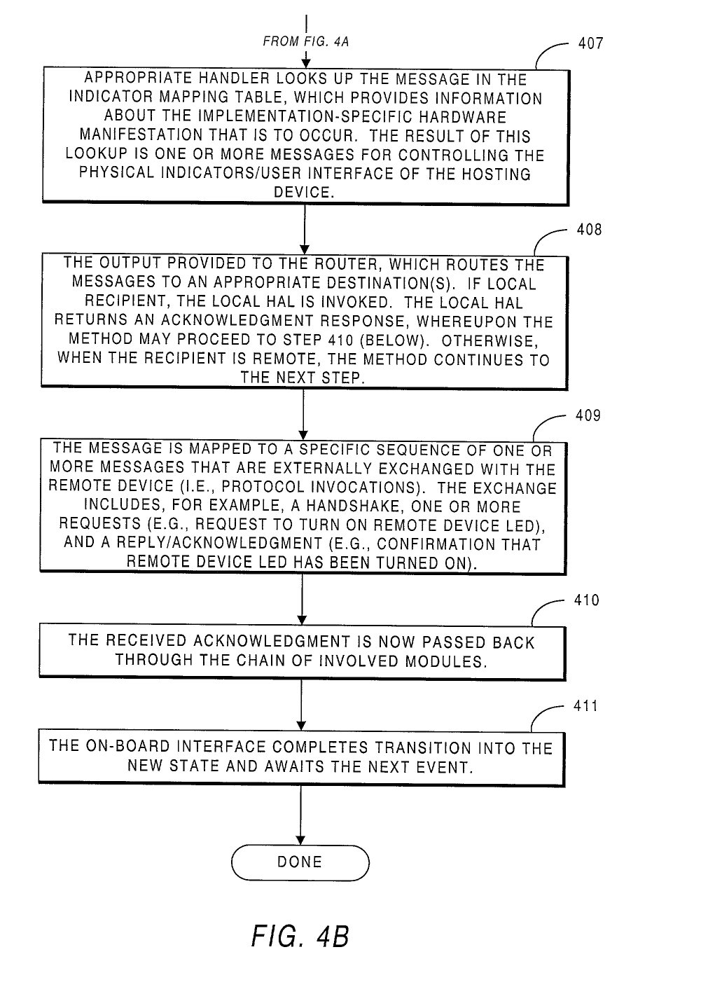

FIG. 4 is a flowchart illustrating internal operation 400. Consider, for example, an instance where the hosting device is a cellular phone and the hosted device (local device) is a media capture device, such as a clip-on digital camera. At step 401, an event occurs (e.g., “low memory” condition) at the local device (clip-on digital camera). The local device will now report this event to the on-board interface. Thus, in the instance of a clip-on digital camera, a camera (software) module within the clip-on camera reports the event to the onboard interface engine (module), as indicated that step 402. The engine processes that message by interacting with the state transition table. As shown at step 403, this entails the following. First, the engine determines the current state(s) of the device. Then, the engine finds a particular entry in the state transition table corresponding to the just-reported event occurring while in the current state. Thus, for example of a “low memory” condition/event, the engine locates a corresponding entry that applies to a “low memory” condition. Now, the engine may effect transition to that new state. During this transition, the engine will update the device's current state information. In addition, the engine will determine a corresponding handler (if any) that should be invoked, as specified by the state transition table entry (i.e., via a pointer to a handler function). However, if no handler is desired, the entry stores a null pointer (value) instead.

As indicated that step 404, the appropriate event handler (if any) is invoked, for carrying out program logic desired for handling that particular event. In the currently preferred embodiment, the handlers are embodied as C++ methods or routines within the onboard interface. As a result of its invocation, the handler posts an abstract message to the UIServices module, as indicated at step 405. For the example of a “low memory” event, the handler would post an abstract message to activate a low-memory indicator. Since the message is abstract, it does not indicate the details of how the low-memory indicator should actually be activated. Instead, the message is a logical UI message indicating the desired implementation-specific hardware manifestation that is to occur.

The message (e.g., “activate low-memory indicator”) is received at the UIServices module, as indicated at step 406. At this point, the message is passed to an appropriate handler within the UIServices module, for interpreting the meaning of the message. At step 407, the appropriate UIServices module handler (i.e., one invoked for the given message) transfers the message to the indicator mapping engine which encapsulates implementation specific information and the processing that produce messages that control the physical indicators/user interface which may be on either the local or remote device.

The output of the UIServices module is provided to the router, which assumes responsibility for routing the messages to an appropriate destination(s). As indicated that step 408, the router in turn determines whether the intended recipient is local or remote. In the case that the recipient is a local, the local Hal (hardware abstraction layer) is invoked, thereby activating the desired hardware/physical manifestation on the local device. The local Hal returns an acknowledgment response, whereupon the method may proceed to step 410 (below). Otherwise, when the recipient is remote, the method continues as follows. The message is routed to the UIProtocol module. At step 409, at the UIProtocol module, the message is mapped to a specific sequence of one or more messages that are externally exchanged with the remote device (i.e., protocol invocations). The exchange includes, for example, a handshake, one or more requests (e.g., request to turn on remote device LED), and a reply/acknowledgment (e.g., confirmation that remote device LED has been turned on). The received acknowledgment is now passed back through the chain of involved modules, as indicated at step 410. Finally, as indicated at step 411, the on-board interface completes transition into the new state and awaits the next event.

The above-described process may occur in reverse, from the perspective of an event occurring on the hosting or remote device. Consider, for example, a scenario where the camera's shutter button is specified to be a particular button on the hosting device (e.g., a button of the cell phone is specified to also serve as a shutter button for the camera). Upon activation of the button at the remote device, a corresponding message is transported via the UIProtocolEntity module to the UIServices module. Here, the UIServices module would map the message from the physical host-specific manifestation to the corresponding inverse entry in the table, that is, the corresponding logical UI message (e.g., “shutter button activated”). This message is then passed to the OnBoardUI module. It in turn instructs the local device (camera) module to undertake the required action (e.g., take a picture). As a result of that sequence of events, the local device may transition to other states, such as a “picture preview” state for a digital camera, which in turn reactivates the process in the forward direction (e.g., for activating user interface elements of the hosting device to provide a preview function).

While the invention is described in some detail with specific reference to a single-preferred embodiment and certain alternatives, there is no intent to limit the invention to that particular embodiment or those specific alternatives. For instance, those skilled in the art will appreciate that modifications may be made to the preferred embodiment without departing from the teachings of the present invention.

What is claimed is:

1. A method for allowing a user interface of a first device to be hosted by a second device, the method comprising:
receiving notification at the first device that an event has occurred that is relevant to said first device;
generating at least one abstract message for indicating that said event has occurred;
based on said at least one abstract message, transmitting to the second device at least one message for activating at least one particular user interface element on the second device; and
in response to said at least one message transmitted to the second device, activating said at least one particular user interface element on the second device.

2. The method of claim 1, wherein said at least one abstract message is generated, at least in part, based on a then-current state of the first device.

3. The method of claim 1, wherein said at least one abstract message is a logical user interface message indicating a logical user interface manifestation that should occur.

4. The method of claim 1, wherein said at least one abstract message itself does not specify activation of particular user interface elements on the second device.

5. The method of claim 1, wherein said at least one message transmitted to the second device does specify activation of one or more particular user interface elements on the second device.

6. The method of claim 1, wherein said first device comprises a client device and wherein said second device comprises a host device to which the client device occasionally connects.

7. The method of claim 1, wherein said step of generating at least one abstract message includes:
determining a new state that is appropriate for the first device to transition to; and
generating at least one abstract message appropriate for indicating the transition to said new state.

8. The method of claim 1, wherein said event comprises a user event.

9. The method of claim 8, wherein said user event comprises user-supplied input.

10. The method of claim 8, wherein said user event comprises user activation of an input element.

11. The method of claim 10, wherein said input element comprises an input button.

12. The method of claim 10, wherein said input element resides on said first device.

13. The method of claim 10, wherein said user input element resides on said second device.

14. The method of claim 13, further comprising:
upon user activation of said user input element residing on said second device, transmitting a notification to said first device.

15. The method of claim 1, further comprising:
passing said at least one abstract message to a router present at the first device, wherein said router determines whether said at least one abstract message is handled locally at the first device or remotely at the second device.

16. The method of claim 1, wherein said at least one particular user interface element comprises an element capable of generating a display.

17. The method of claim 1, wherein said at least one particular user interface element comprises an LED (light-emitting diode).

18. The method of claim 1, wherein said at least one particular user interface element comprises a bitmap display.

19. The method of claim 18, wherein said bitmap display shows an icon in response to receipt of said at least one message for activating at least one particular user interface element on the second device.

20. The method of claim 1, wherein said at least one particular user interface element comprises an element capable of generating sound.

21. A user interface system allowing a user interface of a first device to be supported at least in part by a second device, the system comprising:
a module for generating at least one high-level event message indicating that an event has occurred that is relevant to the first device;
a mapper for mapping said at least one high-level message into at least one lower-level message for controlling one or more hardware elements controlled by the second device; and
a module for communicating said at least one lower-level message to the second device, such that the second device may activate one or more hardware elements that are appropriate for said event that has occurred.

22. The system of claim 21, wherein said first device is temporarily connected to said second device.

23. The system of claim 21, wherein said first device is permanently connected to said second device.

24. The system of claim 21, wherein said first device connects to said second device via wireless communication.

25. The system of claim 21, wherein said first device connects to said second device via wireline communication.

26. The system of claim 21, wherein said first device comprises a client device that is hosted by said second device.

27. The system of claim 21, wherein said first device includes media capture capability.

28. The system of claim 21, wherein said second device includes cellular phone capability.

29. The system of claim 21, wherein said first device also includes hardware elements capable of being controlled by said at least one lower-level message.

30. The system of claim 21, wherein said at least one high-level message is generated, at least in part, based on a then-current state of the first device.

31. The system of claim 21, wherein said at least one high-level message is a logical user interface message indicating a logical user interface manifestation that should occur.

32. The system of claim 21, wherein said at least one high-level message itself does not specify activation of particular hardware elements on the second device.

33. The system of claim 21, wherein said at least one lower-level message does specify activation of one or more particular hardware elements on the second device.

34. The system of claim 21, wherein said first device comprises a client device and wherein said second device comprises a host device to which the client device occasionally connects.

35. The system of claim 21, wherein said module for generating at least one high-level event message determines a new state that is appropriate for the first device to transition to; and generates at least one high-level message appropriate for indicating the transition to said new state.

36. The system of claim 21, wherein said event comprises a user event.

37. The system of claim 36, wherein said user event comprises user-supplied input.

38. The system of claim 36, wherein said user event comprises user activation of an input element.

39. The system of claim 38, wherein said input element comprises an input button.

40. The system of claim 38, wherein said input element resides on said first device.

41. The system of claim 38, wherein said user input element resides on said second device.

42. The system of claim 41, further comprising:
a module for transmitting a notification to said first device in response to user activation of said user input element residing on said second device.

43. The system of claim 21, further comprising:
a router present at the first device for determining whether said at least one abstract message is handled locally at the first device or remotely at the second device.

44. The system of claim 21, wherein said at least one particular hardware element comprises an element capable of generating a display.

45. The system of claim 21, wherein said at least one particular hardware element comprises an LED (light-emitting diode).

46. The system of claim 21, wherein said at least one particular hardware element comprises a bitmap display.

47. The system of claim 46, wherein said bitmap display shows an icon in response to receipt at the second device of said at least one lower-level message.

48. The system of claim 21, wherein said at least one particular hardware element comprises an element capable of generating sound.

49. The system of claim 21, wherein said first device may be embedded within said second device.

50. The system of claim 21, wherein said module for communicating said at least one lower-level message to the second device employs a configurable table so that the second device itself may be selected from different classes of devices.
